(19) United States
(12) Patent Application Publication
(10) Pub. No.: US 2005/0283550 A1
(43) Pub. Date: Dec. 22, 2005

(54) Method and architecture of a coupling system for microprocessors and logic devices

(75) Inventor: Jeremy Ramos, Clearwater, FL (US)

Correspondence Address: Honeywell International Inc.;Law Dept. AB2, 101 Columbia Road, Morristown, NJ, 07962, US

(73) Assignee: Honeywell International Inc.

(21) Appl. No.: 10/872,216

(22) Filed: Jun. 18, 2004

(51) Int. Cl. G06F 13/38

(52) U.S. Cl. 710/62

(57) ABSTRACT

A system for coupling processors and logic devices is provided. The system includes a central processing unit node and a re-configurable computing node that are coupled to a shared memory. The system further includes a discrete I/O bus used for signaling between the central processing unit node and the re-configurable computing node.

### TECHNICAL FIELD

The present invention relates generally to the field of electronic systems and, in particular, to the coupling of logic devices and processors in an electronic system.

### BACKGROUND INFORMATION

In any electronic system, there is a need to connect various subsystem components using data paths. Logic devices such as Field Programmable Gate Arrays (FPGAs) have previously been connected to microprocessors in a variety of ways. Typically, the FPGA is connected to the processor using a standard bus (e.g., a PCI bus).

Most existing techniques have an architecture that connects a Central Processing Unit (CPU) node with a Re-Configurable Computing (RCC) node using an I/O bus. The CPU node has a processor and the RCC node comprises of an FPGA. Typically, software implemented processes are executed in the CPU and hardware implemented tasks are implemented in the FPGA. This type of architecture has the inherent deficiency of having to deal with the multiple copies of data and results that are moved across an I/O bus back and forth between the processor and the logic device. As a result, a bottle neck is created in the I/O bus that slows the effective speed of communication between these devices.

Also, this type of architecture suffers from a common problem of communications overhead. The presence of the communication overhead makes the time taken for the movement of data and results between the processor and the FPGA considerably longer. In addition, the time taken for processing performed in the FPGA is significantly smaller than the waiting time to transport the data and result between the FPGA and the processor. This results in the FPGA remaining idle for a significant period of time and as a result not being fully utilized during the waiting periods. Therefore, the efficiency of the FPGA is lost in the process. One option to overcome this problem is to develop a faster bus. However, developing a faster bus to transport data and results between the processor and the FPGA is not a trivial process.

Another approach to increase the speed of communication between the FPGA and the processor is to manufacture the processor and the FPGA in a common substrate. This is in fact the approach of the state of the art device offerings. However, this is not currently viable for space-based electronic implementations due to the limitations in the fabrication technology available for radiation hardened electronics. Again, improvements in the underlying semiconductor processing to achieve this result would not be trivial.

For the reasons stated above, and for other reasons stated below that will become apparent to those skilled in the art upon reading and understanding the present specification, there is a need in the art for an improved method and architecture for coupling of logic devices and processors together to improve system performance.

### SUMMARY OF INVENTION

The above-mentioned problems with coupling a logic device and a processor are addressed by embodiments of the present invention and will be understood by reading and studying the following specification. Embodiments of the present invention address problems with the delay in movement of data and results between the processor and the logic device. Embodiments of the present invention achieve a tight coupling between the processors and the logic devices for improved data transfer using off-the-shelf electronic components.

In one embodiment, a system is provided having a processor and a logic device and a shared memory wherein the processor is coupled to the logic device through the shared memory to pass data and results between the processor and the logic device.

### BRIEF DESCRIPTION OF DRAWINGS

FIG. 1 is an illustration of one embodiment of a coupling architecture having a logic device and a processor directly coupled with system memory.

FIG. 2a is a flowchart of one embodiment of a method of operation of processing data from a processor that is directly coupled to a logic device using a shared memory.

FIG. 2b is a flowchart of one embodiment of a method of operation of processing results from a logic device that is directly coupled to a processor using a shared memory.

FIG. 3 is a flowchart of one embodiment of a method for handling instructions, data and results between a processor and a logic device.

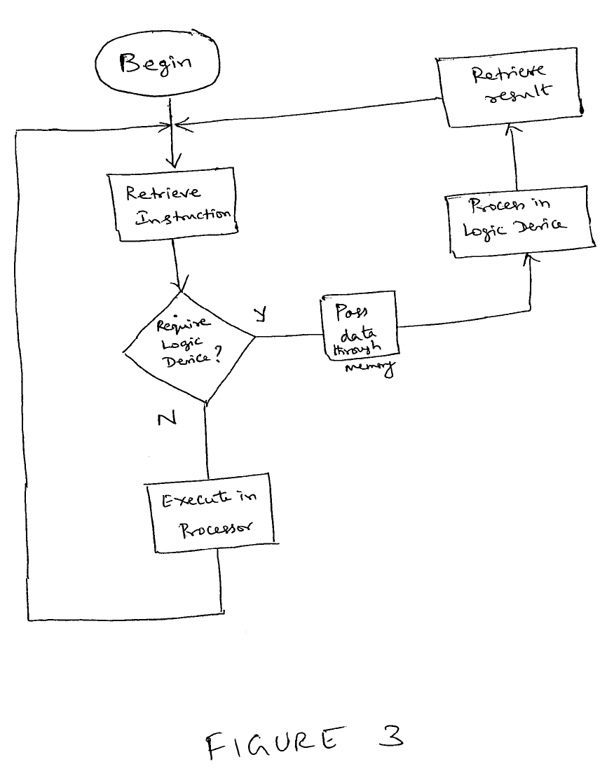

### DETAILED DESCRIPTION

In the following detailed description of the preferred embodiments, reference is made to the accompanying drawings that from a part hereof, and in which is shown by way of illustration specific embodiments in which the invention may be practiced. It is to be understood that other embodiments may be utilized and structural changes may be made without departing from the scope of the present invention. It is also to be understood for the purposes of this specification that the term “directly coupled” means two components coupled to each other without a bus, e.g., without a common pathway, or channel, between multiple devices.

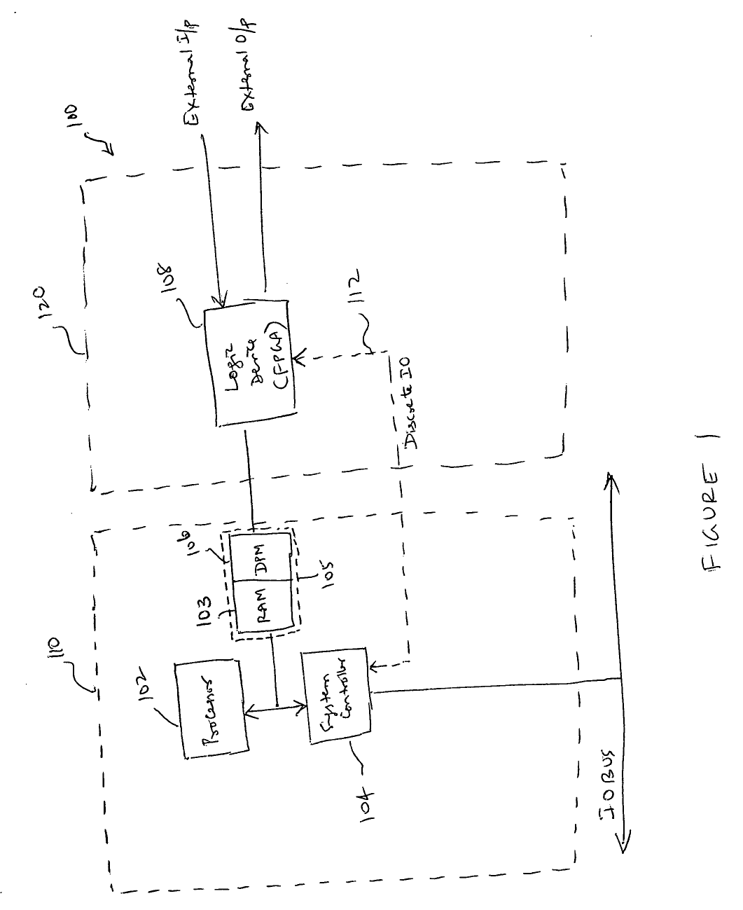

FIG. 1 is an illustration of one embodiment of a system, indicated generally at 100, with an architecture having a Central Processing Unit (CPU) node 110 and a re-configurable computing (RCC) node 120. In one embodiment, CPU node 110 and RCC node 120 are implemented on the same card. In one embodiment RCC node 120 is included in a dual in-line memory module (DIMM). In one embodiment, the central processing unit node 110 includes a processor 102, a system controller 104 and memory 105. In one embodiment, memory 105 is a segmented memory and includes associated memory 103 such as RAM, ROM or flash memory and a shared memory 106 such as a dual port memory (DPM). By using a portion of memory 105 to implement the shared memory 106, system 100 advantageously re-uses existing memory interface capabilities in the system controller 104 and microprocessor 102. In one embodiment, memory 105 is radiation tolerant. In one embodiment, the RCC 120 includes a logic device 108. In one embodiment, the logic device 108 comprises a field programmable gate array (FPGA), adapted to perform specific functions in hardware.

In one embodiment, system controller 104 is a support device for the microprocessor 102. The system controller 104 typically performs many functions which include memory interface controller, interrupt multiplexing, Input/Output (I/O) bus interface, etc. In this context, the system controller 104 functions as a memory controller for the processor 102 thereby, facilitating access to the data and instruction memory of the microprocessor 102. System controllers are generally available as part of a “chip-set” that support the deployment of a particular microprocessor.

Additionally, the system controller 104 implements discrete signal registers that allow the software on the microprocessor 102 to communicate control words to the logic device 108 over discrete I/O 112. Specifically, the system controller 104 uses the discrete signal registers to signal the logic device 108 with a request for processing data in shared memory 106. Since the shared memory 106 can be one of many memory banks in memory 105, use of a system controller 104 avoids the need for an exotic interface for the logic device 108.

Processor 102 comprises either of a special purpose or a general purpose processor, microprocessor, microcontroller, etc. Processor 102 is programmable and operates on instructions stored in a machine or computer readable medium such as associated memory 103.

In one embodiment, the processor 102 and the logic device 108 work together to perform a specified function for system 100. This requires in many cases, that the processor 102 and the logic device 108 share data or manipulate common data. Advantageously, this data is passed back and forth between the devices through the shared memory 106 by removing the requirement of placing the data on a bus to go between the processor 102 and the logic device 108.

Also included in system 100 is a discrete I/O 112 which signals the FPGA that data is available in the dual port memory that requires additional processing. Similarly, when results are available for access in the dual port memory, the FPGA signals the processor 102 using the discrete I/O 112.

In one embodiment, system 100 is made using off-the-shelf, radiation hardened components. Using off-the-shelf components allows high speed communication of data without the need to design a faster bus or to develop new fabrication technology to allow integration of the processor and logic device on the same wafer.

In general, during operation of the system certain functions are performed in the processor 102 and others are performed in the logic device 108. The applications and algorithms are partitioned in such a way that the software implemented processes are executed in the CPU 102 and hardware implemented tasks run on the logic device 108. The CPU node 110 and RCC node 120 share a common resource that is a dual port memory (DPM) 106. The data and results are passed back and forth via the dual port memory 106 rather than using an I/O bus. A single copy of the data is shared by the CPU node 110 and RCC node 120. Additionally, for the same processing task, the time spent to move data from the CPU node 110 to the RCC node 120 is reduced by least 50% in this design when compared to a design using a standard I/O bus architecture. When processor 102 produces a certain data, the logic device 108 can concurrently read that data. This is accomplished by using some type of handshaking between the CPU node 110 and the RCC node 120 using a discrete I/O 112.

In one embodiment, system controller 104 is connected to logic device 108 using a discrete I/O 112 which is implemented through hardware or software. Discrete I/O provides the necessary handshake between the system controller 104 and the logic device 108 to indicate the presence of data in the shared memory 106. This is necessary to coordinate the copying and reading of data and results in the shared memory 106. In one embodiment, logic device 108 such as an FPGA can retrieve data for processing from the shared memory 106 simultaneously as the data is generated and copied by the processor 102 into the system memory 106.

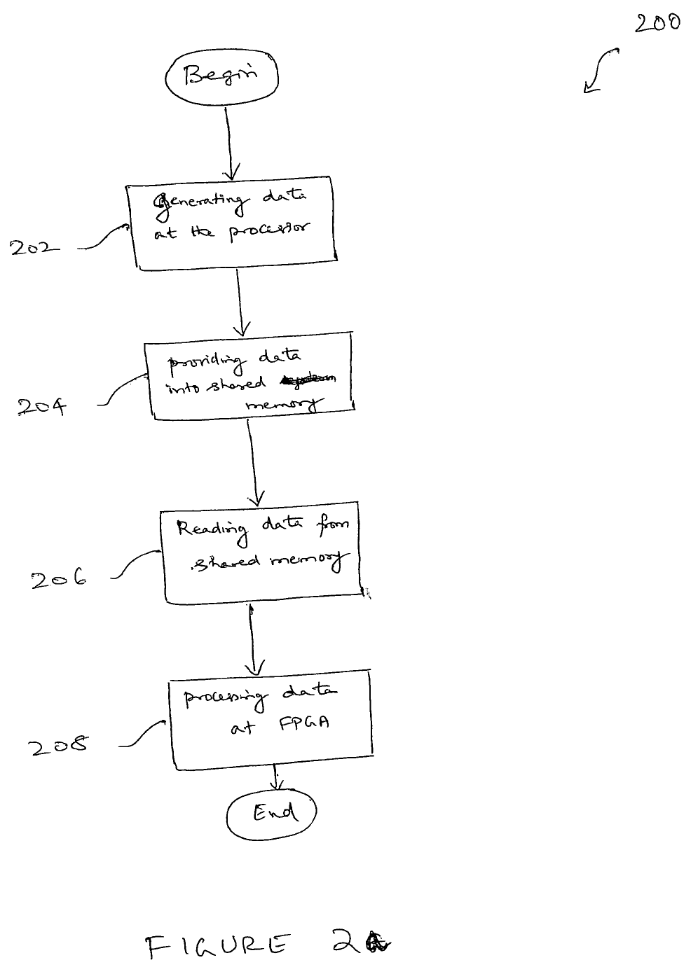

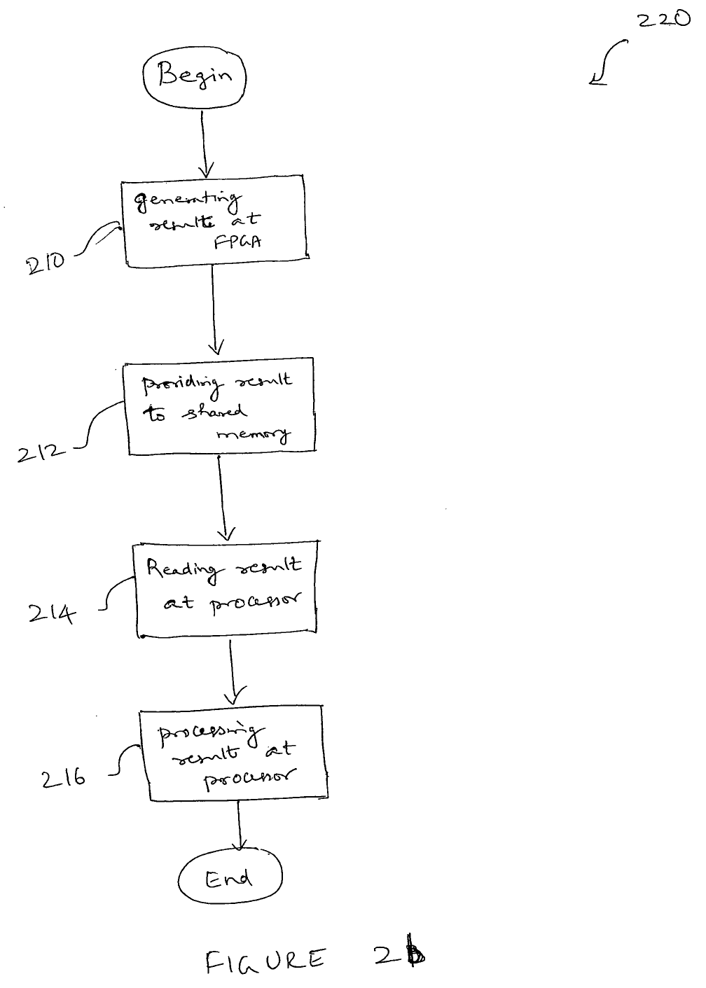

FIG. 2a is a flowchart 200 of one embodiment of a method of operation of processing data from a processor that is directly coupled to a logic device using a shared memory. The method of FIG. 2a begins at block 202 where data is generated in the processor that needs further processing in a logic device such as an FPGA. In order to perform this function, at block 204, the data is copied into the shared memory, e.g., using a system controller. In block 206, the logic device reads the data in order to perform the required operations on the same. In one embodiment, the stored data is simultaneously read as the data is copied onto the shared memory. In block 208, the data is processed in the logic device.

FIG. 2b is a flowchart 220 of one embodiment of a method of operation of processing results from a logic device that is directly coupled to a processor using a shared memory. Following the processing of the data in block 208 at the logic device, the results are generated at the logic device in block 210. These results have to be conveyed to the processor. In order to achieve this function, the results are copied into the shared memory as shown in block 212. Finally, the processor reads the results from the shared memory as shown in block 214. In one embodiment, the processor reads the stored results simultaneously as the results are copied onto the shared memory.

In one embodiment, the above architecture can be utilized in applications by interconnecting FPGAs to external interfaces such as analog-digital and digital-analog converters. In one embodiment, the FPGA hosts an operating system that is implemented in hardware. This would allow for very low overhead context switching since the operating system resides on the FPGA and uses a reduced amount of time of the processor 102.

### CONCLUSION

Embodiments of the present invention have been described. One embodiment provides an architecture that couples a logic device and a processor to using a shared memory. The embodiments significantly reduce the time taken for movement of data and results between the processor's memory and the logic device.

Although specific embodiments have been illustrated and described in this specification, it will be appreciated by those of ordinary skill in the art that any arrangement that is calculated to achieve the same purpose may be substituted for the specific embodiment shown. This application is intended to cover any adaptations or variations of the present invention.

1. A system comprising:
a processor;
a logic device;
a shared memory; and
wherein the processor is coupled to the logic device through the shared memory to pass data and results between the processor and the logic device.

2. The system of claim 1, wherein the processor and the logic device are radiation hardened.

3. The system of claim 1, wherein the shared memory is radiation hardened.

4. The system of claim 1, wherein the shared memory is a dual port memory with a first port coupled to the processor and the second port coupled to the logic device.

5. The system of claim 1, wherein the logic device is a field programmable gate array.

6. The system of claim 5, wherein the field programmable gate array has an operating system that is hardware implemented.

7. A method for communicating data between a processor and a logic device in an electronic system, said method comprising:
generating data at the processor;
providing the data from the processor to a first port of a shared memory;
reading the data from a second port of the shared memory into the logic device; and
processing the data at the logic device.

8. The method in claim 7, wherein processing the data at the logic device comprises processing the data at a field programmable gate array.

9. The method of claim 7, wherein generating data in the processor comprises generating data in a radiation hardened processor; and
processing the data at the logic device comprises processing data in a radiation hardened logic device.

10. A method for communicating data between a logic device and a processor in an electronic system, said method comprising:
processing data in a logic device;
generating results at the logic device;
providing the results from the logic device to a first port of a shared memory;
reading results from a second port of the shared memory into the processor; and
processing the results at the processor.

11. The method in claim 10, wherein processing the data in the logic device comprises processing the data in a field programmable gate array.

12. The method of claim 7, wherein generating the results in the processor comprises processing the results in a radiation hardened processor; and
processing the data in the logic device comprises processing data in a radiation hardened logic device.

13. A system for coupling processors and logic devices comprising:
a central processing unit node;
a re-configurable computing node;
a discrete I/O bus; and
wherein the central processing unit node and the re-configurable computing node are directly coupled to a shared memory.

14. The system of claim 13, wherein the central processing unit includes a processor and a system controller.

15. The system of claim 13, wherein the re-configurable computing node includes a shared memory and a logic device.

16. The system of claim 13, wherein the central processing unit node is radiation hardened.

17. The system of claim 13, wherein the re-configurable computing node is radiation hardened.

18. The system of claim 13, wherein the discrete I/O bus provides signaling between the central processing unit node and the re-configurable computing node.

19. A method for communicating data between a central processing unit node and a re-configurable computing node in an electronic system, said method comprising:
generating data at the central processing unit node;
providing the data from the central processing unit to a shared memory;
reading the data from the shared memory into the re-configurable computing node; and
processing the data at the re-configurable computing node.

20. The method of claim 19, wherein reading data from the shared memory comprises reading data substantially simultaneously as the data is provided to the shared memory by the central processing node.

21. The method of claim 19, wherein reading the data from a shared memory comprises reading the data from a dual port memory.

22. The method of claim 19, and further comprising providing results back to the re-configurable computing node through the shared memory.

23. The method of claim 19, wherein generating data at the central processing unit node comprises generating data at a radiation hardened central processing unit node.

24. The method of claim 19, wherein processing the data at the re-configurable computing node comprises processing the data at the re-configurable computing node with a radiation hardened logic device.

25. A system for connecting logic devices comprising:
a first logic device;
a second logic device;
a shared memory; and
wherein the first logic device is directly coupled to the second logic device using the shared memory.

26. The system of claim 25, wherein the first logic device is a field programmable gate array.

27. The system of claim 25, wherein the field programmable gate array has an operating system that is hardware implemented.

28. The system of claim 25, wherein the second logic device is an analog-digital converter.

29. The system in claim 25, wherein the second logic device is a digital-analog converter.

30. The system in claim 25, wherein the shared memory is a dual port memory.

31. A method for processing data, the method comprising:
processing first data in a processor based on stored instructions;
processing other data in a logic device based on a hardware configuration of the logic device; and
passing data and results between the processor and logic device using a shared memory that is directly accessible by both processor and the logic device.
